(19) United States
(12) Patent Application Publication
(10) Pub. No.: US 2015/0204324 A1
(43) Pub. Date: Jul. 23, 2015

(54) Drive Assembly for a Rotary Fluid Pressure Device

(71) Applicant: Eaton Center, Cleveland, OH (US)

(72) Inventors: Aaron Kelly Krahn, Eden Prairie, MN (US); Neil West Murphy, Portsmouth (GB)

(21) Appl. No.: 14/408,817

(22) PCT Filed: Jun. 27, 2013
(86) PCT No.: PCT/US2013/048181

§ 371 Date: Dec. 17, 2014

Related U.S. Application Data
(60) Provisional application No. 61/665,544, filed on Jun. 28, 2012.

(51) Int. Cl. F04C 2/08; B62D 5/06; B23P 19/04; F04C 15/00; F04C 15/06

(52) U.S. Cl. CPC F04C 2/084; F04C 15/0057; F04C 15/064; B23P 19/04; B62D 5/062

(57) ABSTRACT

A rotary fluid pressure device includes a housing section defining an inlet port and a return port. A valving assembly is in fluid communication with the inlet port and the return port. A first fluid meter defines a plurality of volume chambers that are in fluid communication with the valving assembly. A second fluid meter defines a second plurality of volume chambers in selective fluid communication with the valving assembly. A drive assembly is engaged with the first fluid meter and the second fluid meter. The drive assembly has a drive shaft and a drive collar. The drive shaft has a first axial end portion engaged with the first fluid meter and an oppositely disposed second axial end portion, the drive collar is removably coupled to the second axial end portion of the drive shaft. The drive collar is engaged with the second fluid meter.

### CROSS REFERENCE TO RELATED APPLICATIONS

This application is being filed on 27 Jun. 2013 as a PCT International

Patent Application in the name of Eaton Corporation, a U.S. national corporation, applicant for the designation of all countries and claims priority to U.S. Patent Application Ser. No. 61/665,544 filed on 28 Jun. 2012, the disclosure of which is hereby incorporated by reference in its entirety.

### BACKGROUND

Hydraulic steering units are used in a variety of agriculture and construction type off-highway vehicles. Hydraulic steering unites typically include a displacement assembly that is used to displace fluid from the steering unit in response to rotations of a steering actuator, such as a steering wheel. However, in certain applications, it is desirable for the hydraulic steering unit to provide different rates at which fluid is displaced from the steering unit for a given rotation speed of the steering actuator.

Two-speed steering units have a first mode in which all of the fluid from the steering unit is displaced by a first displacement assembly and a second mode in which the fluid from the steering unit is displaced by the first displacement assembly and a second displacement assembly. In this second mode, the amount of fluid displaced per revolution of the steering actuator is greater than in the first mode.

While two-speed steering units are currently available and prove adequate for most applications, there exists a need for a more efficient two-speed steering unit.

### SUMMARY

An aspect of the present disclosure relates to a rotary fluid pressure device. The rotary fluid pressure device includes a housing section defining an inlet port and a return port. A valving assembly is in fluid communication with the inlet port and the return port. A fluid meter has a ring and a star. The ring and the star cooperatively define a plurality of volume chambers that are in fluid communication with the valving assembly. The star includes a plurality of internal splines. A drive assembly has a drive shaft and a drive collar. The drive shaft has a first axial end portion and an oppositely disposed second axial end portion. The first axial end portion has a plurality of external splines. The drive collar is removably coupled to the second axial end portion, the drive collar has a plurality of external splines that is engaged with the internal splines of the star of the fluid meter.

Another aspect of the present disclosure relates to a rotary fluid pressure device. The rotary fluid pressure device includes a housing section defining an inlet port and a return port. A valving assembly is in fluid communication with the inlet port and the return port. A first fluid meter has a ring and a star that cooperatively define a plurality of expanding and contracting volume chambers. The volume chambers are in fluid communication with the valving assembly. A second fluid meter has a ring and a star that cooperatively define a second plurality of expanding and contracting volume chambers. The second plurality of volume chambers is in selective fluid communication with the valving assembly. A drive assembly is engaged with the first fluid meter and the second fluid meter. The drive assembly has a drive shaft and a drive collar. The drive shaft has a first axial end portion engaged with the star of the first fluid meter and an oppositely disposed second axial end portion, the drive collar is removably coupled to the second axial end portion of the drive shaft. The drive collar is engaged with the star of the second fluid meter.

Another aspect of the present disclosure relates to a method of assembling a rotary fluid pressure device. The method includes engaging external splines of a first axial end portion of a drive shaft with internal splines of a star of a first fluid meter. A body of the drive shaft is inserted through a central bore of a selector assembly. A drive collar is coupled to a second axial end portion of the drive shaft. External splines on the drive collar are engaged with internal splines of a star of a second fluid meter.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

FIG. 1 is a hydraulic schematic of a hydraulic circuit having exemplary features of aspects in accordance with the principles of the present disclosure.

FIG. 2 is an isometric view of a rotary fluid pressure device.

FIG. 3 is a cross-sectional view of the rotary fluid pressure device of FIG. 2.

FIG. 4 is a front view of a fluid meter suitable for use in the rotary fluid pressure device of FIG. 2.

FIG. 5 is an isometric view of a drive assembly suitable for use with the rotary fluid pressure device of FIG. 2.

FIG. 6 is an isometric view of a drive shaft suitable for use with the drive assembly of FIG. 5.

FIG. 7 is a front view of the drive shaft of FIG. 6.

FIG. 8 is a side view of the drive shaft of FIG. 6.

FIG. 9 is a back view of the drive shaft of FIG. 6.

FIG. 10 is an isometric view of a drive collar suitable for use with the drive assembly of FIG. 5.

FIG. 11 is a side view of the drive collar of FIG. 10.

FIG. 12 is a front view of the drive collar of FIG. 10.

### DETAILED DESCRIPTION

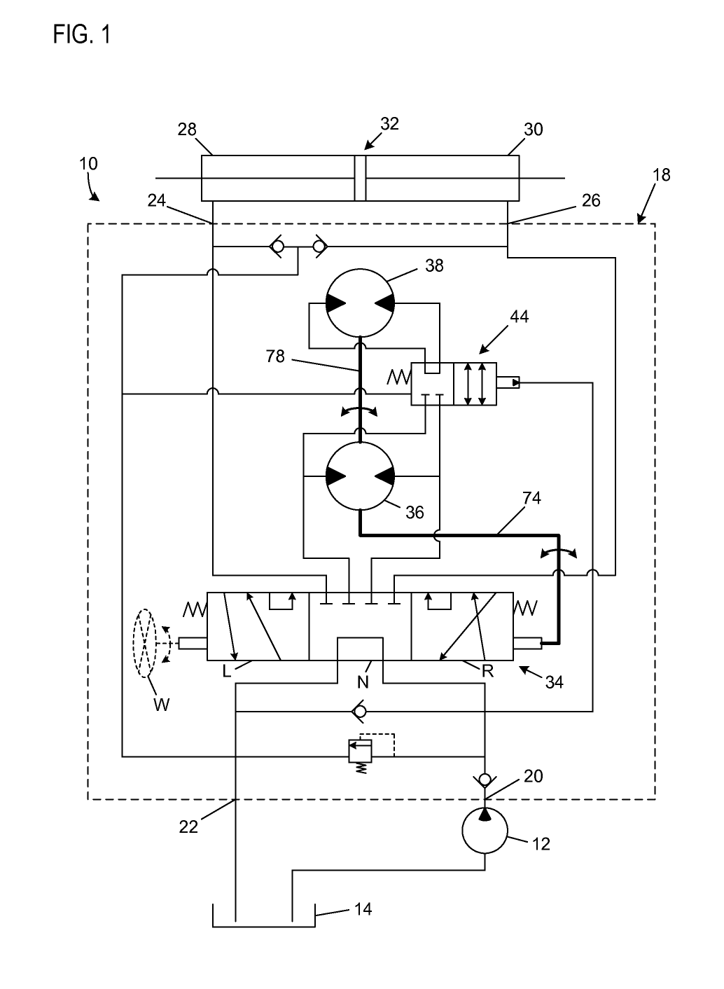

Reference will now be made in detail to the exemplary aspects of the present disclosure that are illustrated in the accompanying drawings. Wherever possible, the same reference numbers will be used throughout the drawings to refer to the same or like structure. Referring now to FIG. 1, a hydraulic circuit 10 is shown. The hydraulic circuit 10 includes a fluid pump 12, shown herein as a fixed displacement pump, having its inlet connected to a system reservoir 14 and its outlet in fluid communication with a rotary fluid pressure device 18. In the depicted embodiment, the rotary fluid pressure device 18 is a fluid controller. It will be understood, however, that the scope of the present disclosure is not limited to the rotary fluid pressure device 18 being a fluid controller as the rotary fluid pressure device alternatively could be a fluid motor (e.g., spool-valve motor, disc-valve motor, valve-in-star motor, etc.).

In the depicted embodiment, the rotary fluid pressure device 18 includes an inlet port 20, a return port 22, a first control port 24 and a second control port 26. In the subject embodiment, the first and second control ports 24, 26 are in fluid communication with a first end 28 and an oppositely disposed second end 30 of a steering cylinder 32, respectively.

The rotary fluid pressure device 18 includes a valving assembly 34. The valving assembly 34 is in fluid communication with the inlet port 20 and the return port 22. In the subject embodiment, the valving assembly 34 is movable from a neutral position N (shown in FIG. 1) to either a right turn position R or a left turn position L. When the valving assembly 34 is in either the right turn position R or the left turn position L, fluid is communicated through at least one of a first fluid meter 36 and a second fluid meter 38 to one of the first and second ends 28, 30 of the cylinder 32. One example of a valving assembly 34 that is suitable for use in the rotary fluid pressure device 18 of the present disclosure is disclosed in U.S. Pat. No. 4,109,679, which is hereby incorporated by reference in its entirety. It will be understood, however, that the scope of the present disclosure is not limited to the valving assembly 34 being of the type described in U.S. Pat. No. 4,109,679.

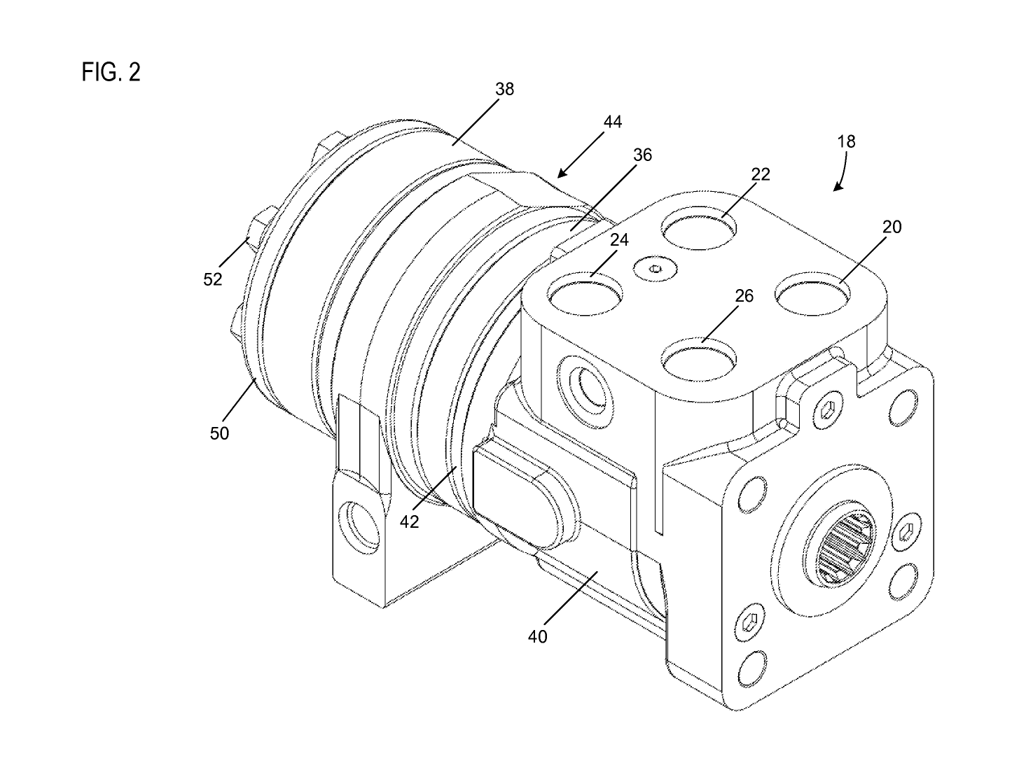

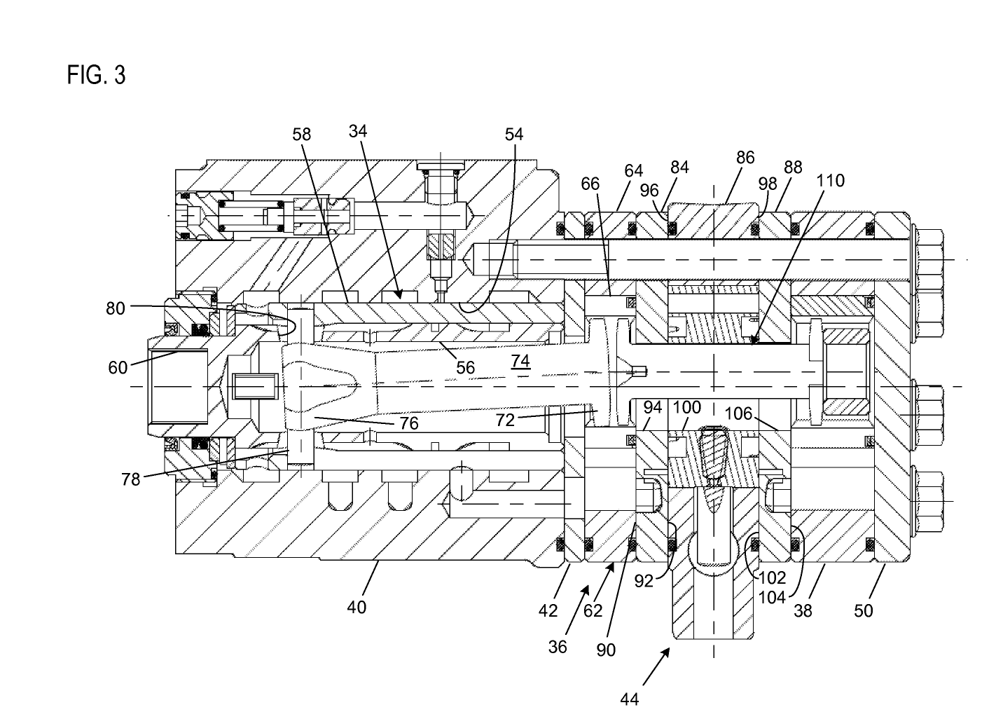

Referring now to FIGS. 2 and 3, the rotary fluid pressure device 18 includes a plurality of sections, including a housing section, generally designated 40, a port plate 42, the first fluid meter 36, a selector assembly 44, the second fluid meter 38, and an end cap 50. The plurality of sections are held together in tight, sealing engagement by a plurality of fasteners 52 (e.g., bolts, cap screws, etc.). In the subject embodiment, the plurality of fasteners 52 is in threaded engaged with the housing section 40.

The housing section 40 defines the inlet and outlet ports 20, 22 and the first and second control ports 24, 26. The housing section 40 further defines a valving bore 54 in which the valving assembly 34 is rotatably disposed.

In the subject embodiment, the valving assembly 34 includes a rotatable valve member 56 (hereinafter referred to as the “spool”) and a cooperating, relatively rotatable follow-up valve member 58 (hereinafter referred to as the “sleeve”). At a first end of the spool 56 is a portion having a reduced diameter and defining a set of internal splines 60 that provide a mechanical interface between the spool 56 and a steering wheel W (shown schematically in FIG. 1).

Referring now to FIGS. 1, 3 and 4, each of the first and second fluid meters 36, 38 includes a gerotor gear set, generally designated 62. The gerotor gear set 62 includes an internally-toothed ring 64 and an externally toothed star 66. The internally-toothed ring 64 and the externally toothed star 66 cooperatively define a plurality of expanding and contracting volume chambers 68. The number of volume chambers 68 in each gerotor gear set 62 is equal to the number of teeth disposed externally on the star 66 plus one. In the subject embodiment, the number of volume chambers 68 defined by the first fluid meter 36 is equal to the number of volume chambers 68 defined by the second fluid meter 38.

The star 66 of each of the first and second fluid meters 36, 38 defines a set of internal splines 70. In the subject embodiment, the internal splines 70 of the first fluid meter 36 are engaged with an externally splined end 72 of a main drive 74. The main drive 74 mechanically couples the star 66 of the first fluid meter 36 to the sleeve 58.

The main drive 74 includes a bifurcated end 76 that is oppositely disposed from the externally splined end 72. The bifurcated end 76 connects the main drive 74 and the sleeve 58 through a pin 78 that passes through a pair of circumferentially elongated pin openings 80 in the spool 56.

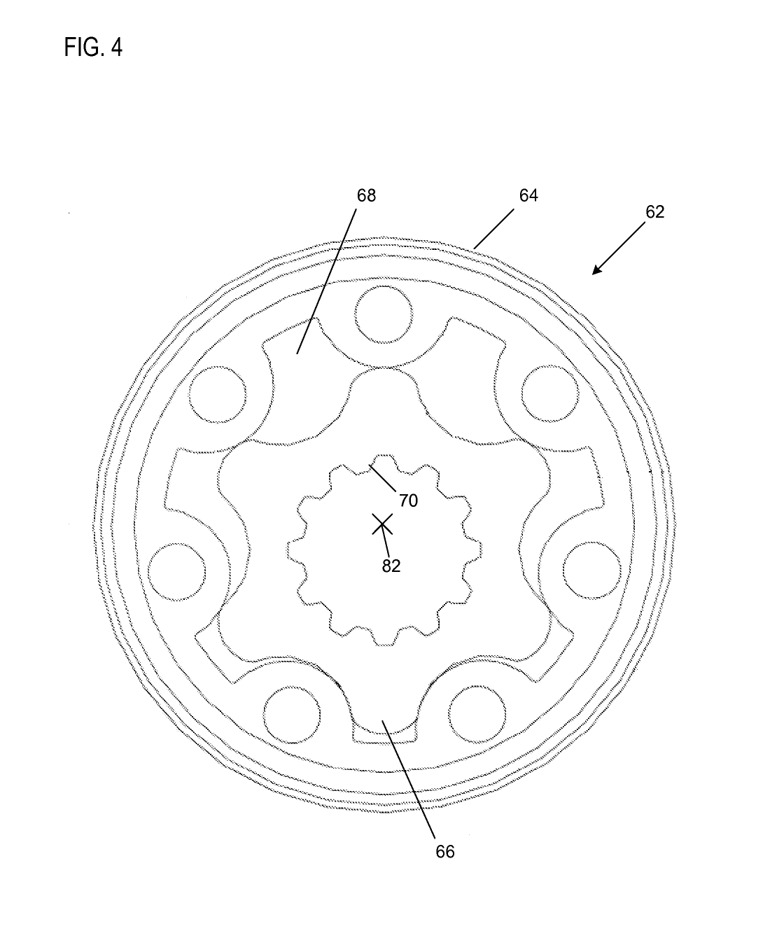

In operation, as the steering wheel W is turned, the spool 56 is rotationally displaced from the sleeve 58. This rotational displacement causes pressurized fluid to flow through the valving assembly 34 into the expanding volume chambers 68 of at least the first fluid meter 36. As the pressurized fluid enters the expanding volume chamber 68 of the at least first fluid meter 36, the star 66 orbits and rotates about a central axis 82 (shown as an “X” in FIG. 4) of the ring 64. The orbital and rotational movement of the star 66 about the central axis 82 of the ring 64 causes pressurized fluid to be expelled from the contracting volume chambers 68 of the at least first fluid meter 36 and flow through the valving assembly 34 to the cylinder 32. The engagement between the bifurcated end 76 of the main drive 74, the pin 78, and the sleeve 58 and the orbital and rotational movement of the star 66 within the ring 64 causes the sleeve 58 to rotate within the valve bore 54 of the housing section 40. This rotation of the sleeve 58 in the valve bore 54 allows the sleeve 58 to “follow” the rotation of the spool 56, which maintains an appropriate relative rotational displacement between the spool 56 and the sleeve 58. The degree of displacement between the spool 56 and the sleeve 58 corresponds to a rate of rotation of the steering wheel W. For example, at a given rotation rate of the steering wheel W, the spool 56 is rotationally displaced from the sleeve 58 allowing fluid to flow to the cylinder 32 at a metered rate. If the rotation rate of the steering wheel W is increased, the rotational displacement of the spool 56 and the sleeve 58 is also increased allowing fluid to flow to the cylinder 32 at a higher metered rate.

In the subject embodiment, the rotary fluid pressure device 18 includes two fluid meters, the first and second fluid meters 36, 38, and the selector assembly 44 disposed between the first and second fluid meters 36, 38. The selector assembly 44 provides selective fluid communication between the first and second fluid meters 36, 38.

Actuation of the selector assembly 44 to a first position opens fluid communication between the first and second fluid meters 36, 38, which increases the effective displacement of the rotary fluid pressure device 18. Actuation of the selector assembly 44 to a second position blocks fluid communication between the first and second fluid meters 36, 38, which decreases the effective displacement of the rotary fluid pressure device 18. By increasing or decreasing the effective displacement of the rotary fluid pressure device 18, the actuation of the selector assembly 44 between the first and second positions allows the rotary fluid pressure device 18 to communicate fluid to the cylinder 32 at different metered rates for a given rotation rate of the steering wheel W. The different metered rates for a given rotation rate of the steering wheel W affects the number of turns of the steering wheel to move the valving assembly 34 from the left position L to the right position R (i.e. lock-to-lock). The selector assembly 44 and the operation of the selector assembly 44 have been described in U.S. Patent Application Publication No. 20090199915, the disclosure of which is hereby incorporated by reference in its entirety.

In subject embodiment, the selector assembly 44 includes a first wear plate 84, a selector plate assembly 86 and a second wear plate 88. The first wear plate 84 is disposed between the selector plate assembly 86 and the first meter 36 while the second wear plate 88 is disposed between the selector plate assembly 86 and the second meter 38. In the depicted embodiment, the first wear plate 84 is disposed immediately between the selector plate assembly 86 and the first meter 36 while the second wear plate 88 is disposed immediately between the selector plate assembly 86 and the second meter 38.

The first wear plate 84 includes a first side 90 and an oppositely disposed second side 92. The first side 90 is disposed adjacent to the first fluid meter 36 and the second side 92 is disposed adjacent the selector plate assembly 86. The first wear plate 84 defines a central opening 94 that extends through the first and second sides 90, 92.

The selector plate assembly 86 includes a first face 96 and an oppositely disposed second face 98. The first face 96 is disposed adjacent to the second side 92 of the first wear plate 84 and the second face 98 is disposed adjacent the second wear plate 88. The selector plate assembly 86 defines a central bore 100 that extends through the first and second faces 96, 98. The central bore 100 is aligned with the central opening 94 of the first wear plate 84.

The second wear plate 88 includes a first surface 102 and an oppositely disposed second surface 104. The first surface 102 is disposed adjacent to the second face 98 of the selector plate assembly 86 and the second surface 104 is disposed adjacent the second fluid meter 38. The second wear plate 88 defines a central opening 106 that extends through the first and second surfaces 102, 104. The central opening 106 of the second wear plate 88 is aligned with the central opening 94 of the first wear plate 84 and the central bore 100 of the selector plate assembly 86.

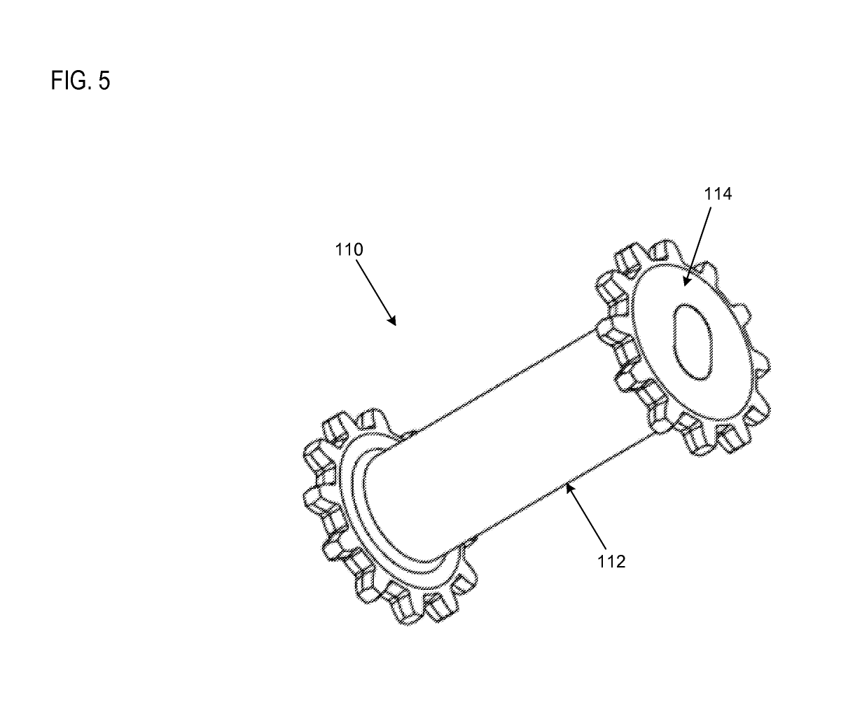

Referring now to FIGS. 3 and 5, the rotary fluid pressure device 18 includes a drive assembly 110. In the depicted embodiment, the drive assembly 110 mechanically couples the star 66 of the first fluid meter 36 to the star 66 of the second fluid meter 38. The drive assembly 110 includes a drive shaft 112 and a drive collar 114 removably engaged to the drive shaft 112.

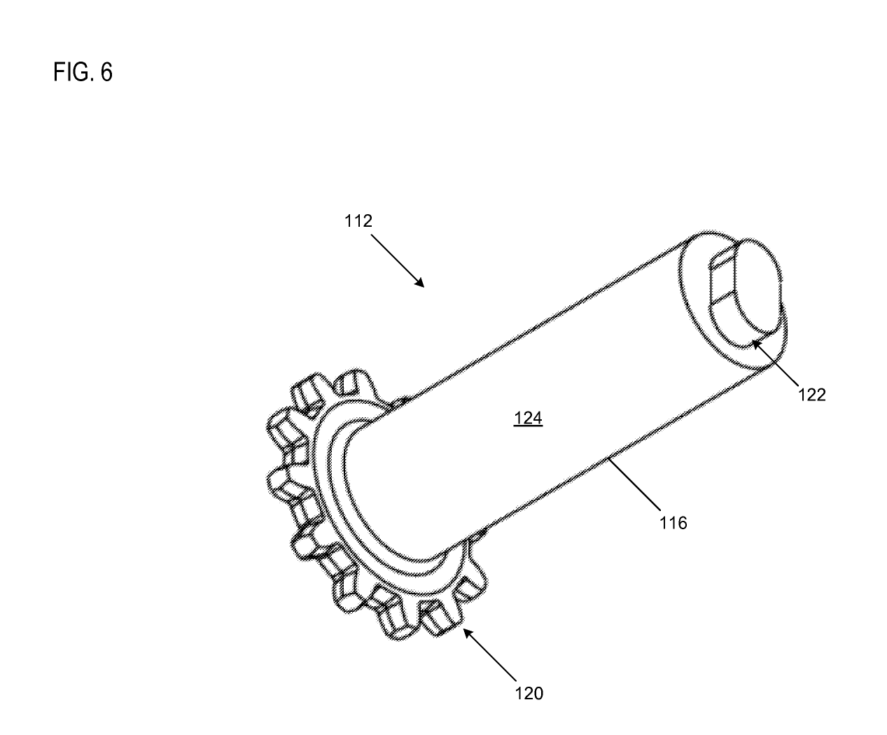

Referring now to FIGS. 6-9, the drive shaft 112 of the drive assembly 110 is shown. The drive shaft 112 includes a body 116 defining a central longitudinal axis 118. The body 116 includes a first axial end portion 120 and an oppositely disposed second axial end portion 122. In the depicted embodiment, the body 116 of the drive shaft 112 has an outer surface 124 that is generally cylindrical in shape between the first and second axial end portions 120, 122. In the depicted embodiment, the outer surface 124 has an outer diameter D₁.

The first axial end portion 120 extends radially outward from the outer surface 124 of the body 116. In the depicted embodiment, the first axial end portion 120 includes a plurality of external splines 126. In the depicted embodiment, the external splines 126 are adapted for engagement with the internal splines 70 of the first meter 38. An outer diameter D₂ of a circle 128 (shown in dotted lines) circumscribing the first axial end portion 120 is greater than the outer diameter D₁ of the outer surface 124 of the body 116.

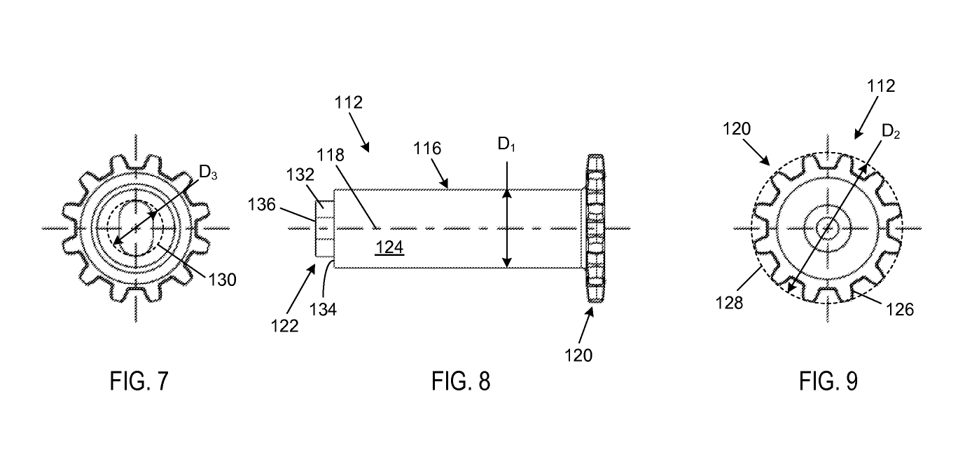

The second axial end portion 122 extends outwardly in an axial direction along the central longitudinal axis 118 of the body 116. In the depicted embodiment, the second axial end portion 122 is generally obround in shape. An outer diameter D₃ of a circle 130 (shown in dotted lines in FIG. 7) circumscribing the second axial end portion 122 is less than the outer diameter D₂ of the first axial end portion 120. In the depicted embodiment, the outer diameter D₃ of the second axial end portion 122 is less than an outer diameter D₁ of the outer surface 124 of the body 116.

In the depicted embodiment, the second axial end portion 122 of the body 116 includes a perimeter surface 132 that extends along the central longitudinal axis 118 of the body 116. The perimeter surface 132 is generally parallel to the central longitudinal axis 118. The second axial end portion 122 further includes a shoulder surface 134 that is generally perpendicular to the central longitudinal axis 118 of the body 116. In the depicted embodiment, the shoulder surface 134 extends between the outer surface 124 of the body 116 and the perimeter surface 132 of the second axial end portion 122.

The second axial end portion 122 further includes an end surface 136. In the depicted embodiment, the end surface 136 is generally perpendicular to the central longitudinal axis 118 of the body 116 and is generally parallel to the shoulder surface 134.

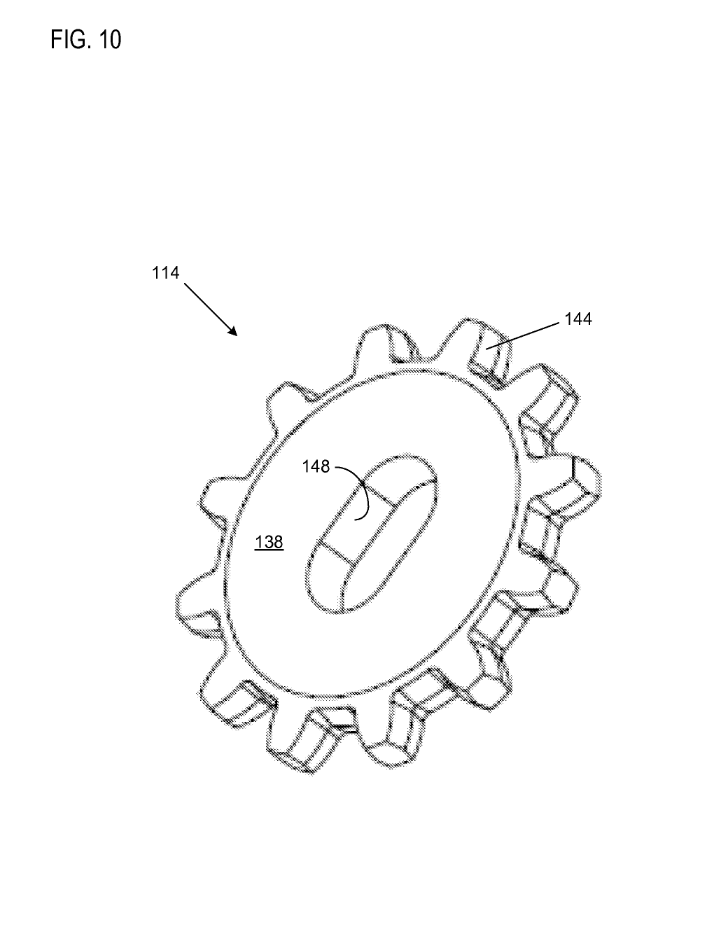

Referring now to FIGS. 10-12, the drive collar 114 is shown. The drive collar 114 is adapted for removable engagement with the second axial end portion 122 of the drive shaft 112. In the subject embodiment, the drive collar 114 is coupled to the drive shaft 112 so that rotation of the drive shaft 112 results in corresponding rotation of the drive collar 114.

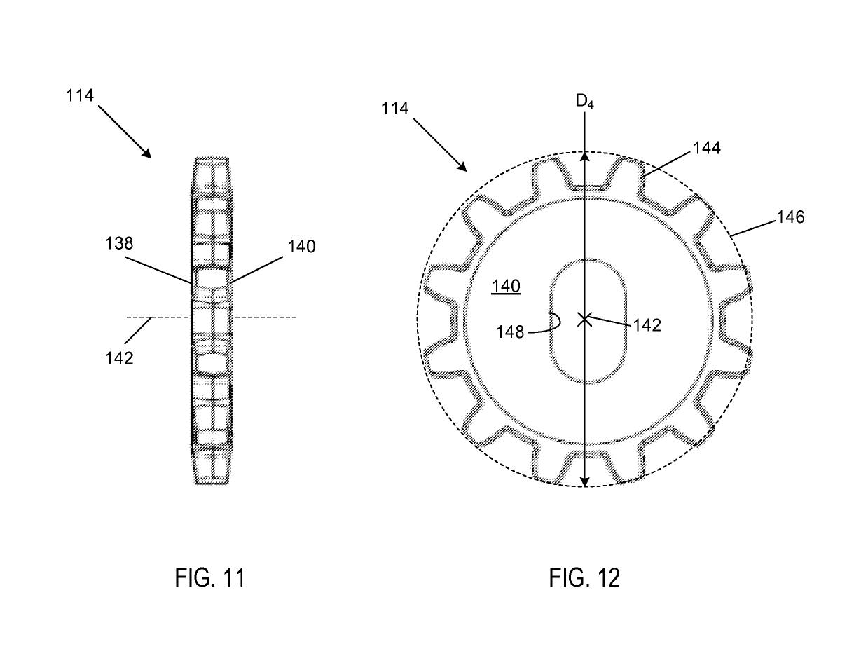

The drive collar 114 includes a first face 138 and an oppositely disposed second face 140. The drive collar 114 defines a central axis 142 (shown in FIGS. 11 and 12) that extends through first and second faces 138, 140.

The drive collar 114 further includes a plurality of external splines 144. In the depicted embodiment, the external splines 144 are adapted for engagement with the internal splines 70 of the second fluid meter 40.

The drive collar 114 defines a circle 146 (shown in dotted lines in FIG. 12) circumscribing the external splines 144 of the drive collar 114. In the depicted embodiment, an outer diameter D₄ of the circle 146 is greater than the outer diameter D₁ of the body 116 of the drive shaft 112. In the depicted embodiment, the outer diameter D₄ of the circle 146 is about equal to the outer diameter D₂ of the first axial end portion 120.

The drive collar 114 defines a central bore 148 that extends through the first and second faces 138, 140 along the central axis 142. The central bore 148 is adapted to receive at least a portion of the second axial end portion 122 of the drive shaft 112. In the subject embodiment, the central bore 148 has a shape that is similar to the shape of the second axial end portion 122 of the body 116 of the drive shaft 112. In the depicted embodiment, the central bore 148 is generally obround in shape.

Referring now to FIGS. 5-12, the assembly of the drive assembly 110 will be described. The central longitudinal axis 118 of the drive shaft 112 and the central axis 142 of the drive collar 114 are aligned. With the central longitudinal axis 118 and the central axis 142 aligned, the central bore 148 of the drive collar 114 is aligned with the second axial end portion 122 of the drive shaft 112. The second axial end portion 122 is inserted into the central bore 142 until the shoulder surface 134 of the drive shaft 112 abuts the first face 138 of the drive collar 114. In one embodiment, the fit between the second axial end portion 122 of the drive shaft 112 and the central bore 148 of the drive collar 114 is a close fit. In another embodiment, the fit between the second axial end portion 122 of the drive shaft 112 and the central bore 148 of the drive collar 114 is an interference fit.

Referring now to FIGS. 3 and 5-12, the assembly of the rotary fluid pressure device 10 will be described. The splines 126 of the first axial end portion 120 of the drive shaft 112 are engaged with the splines 70 of the star 66 of the first fluid meter 36. The second axial end portion 122 of the drive shaft 122 is passed through the central bore 100 of the selector plate assembly 86. After the second axial end portion 122 is passed through the central bore 100, the central longitudinal axis 118 of the drive shaft 112 and the central axis 142 of the drive collar 114 are aligned. With the central longitudinal axis 118 and the central axis 142 aligned, the central bore 148 of the drive collar 114 is aligned with the second axial end portion 122 of the drive shaft 112. The second axial end portion 122 is inserted into the central bore 142 until the shoulder surface 134 of the drive shaft 112 abuts the first face 138 of the drive collar 114. The splines 144 of the drive collar 114 are engaged with the splines 70 of the star 66 of the second fluid meter 38. The central bore 100 of the selector plate assembly 86 is sized so that the inner diameter of the central bore 100 is less than the outer diameter D₄ of drive collar 114 and greater than the outer diameter D₁ of the body 116 plus two times the eccentricity of the first fluid meter 38. By providing an inner diameter of the central bore 100 of the selector plate assembly 86 that is less than the outer diameter of the drive collar 114, the volumetric efficiency of the rotary fluid pressure device can be increased since there is more sealing land between volume chambers 68 of the first fluid meter 38 and the central bore 100 of the selector plate assembly 86, which reduces leakage.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A rotary fluid pressure device comprising:
a housing section defining an inlet port and a return port;
a valving assembly being in fluid communication with the inlet port and the return port;
a first fluid meter having a ring and a star defining a plurality of expanding and contracting volume chambers, wherein the volume chambers are in fluid communication with the valving assembly;
a second fluid meter having a ring and a star cooperatively defining a second plurality of expanding and contracting volume chambers, wherein the volume chambers are in selective fluid communication with the valving assembly; and
a drive assembly engaged with the first fluid meter and the second fluid meter, the drive assembly having a drive shaft and a drive collar, the drive shaft having a first axial end portion engaged with the star of the first fluid meter and an oppositely disposed second axial end portion, the drive collar being removably coupled to the second axial end portion of the drive shaft, the drive collar engaged with the star of the second fluid meter.

2. The rotary fluid pressure device of claim 1, wherein the drive collar includes a plurality of external splines that is in splined engagement with the star of the second fluid meter.

3. The rotary fluid pressure device of claim 1, wherein second axial end portion of the drive shaft is generally obround in shape.

4. The rotary fluid pressure device of claim 1, further comprising a selector assembly that provides selective fluid communication between the first fluid meter and the second fluid meter.

5. The rotary fluid pressure device of claim 4, wherein the selector assembly is disposed between the fluid meter and the second fluid meter.

6. The rotary fluid pressure device of claim 5, wherein the drive shaft extends through a central bore of the selector assembly.

7. The rotary fluid pressure device of claim 1, wherein rotary fluid pressure device is a steering unit.

8. The rotary fluid pressure device of claim 1, wherein the drive collar is in close fit engagement with the second axial end portion of the drive shaft.

9. The rotary fluid pressure device of claim 1, wherein the drive collar is in interference fit engagement with the second axial end portion of the drive shaft.

10. The rotary fluid pressure device of claim 1, wherein an outer diameter of the drive collar is about equal to an outer diameter of the first axial end portion of the drive shaft.

11. A method for assembling a rotary fluid pressure device, the method comprising:
engaging external splines of a first axial end portion of a drive shaft with internal splines of a star of a first fluid meter;
inserting a body of the drive shaft through a central bore of a selector assembly;
coupling a drive collar to a second axial end portion of the drive shaft; and
engaging external splines on the drive collar with internal splines of a star of a second fluid member.

12. The method of claim 11, wherein rotary fluid pressure device is a steering unit.

13. The method of claim 11, wherein the drive collar is in close fit engagement with the second axial end portion of the drive shaft.

14. The method of claim 11, wherein the second axial end portion of the drive shaft is generally obround in shape.

15. The method of claim 11, wherein the drive collar abuts a shoulder surface of the drive collar.
